(19) United States
(12) Patent Application Publication
(10) Pub. No.: US 2023/0018336 A1
(43) Pub. Date: Jan. 19, 2023

(54) AIR FILTER FOR AIR CONDITIONING SYSTEM

(71) Applicant: Langston Engineering Limited, London (GB)

(72) Inventor: Noel Martin Paterson, London (GB)

(21) Appl. No.: 17/791,049

(22) PCT Filed: Jan. 7, 2021
(86) PCT No.: PCT/EP2021/050201

§ 371 Date: Jul. 6, 2022

(30) Foreign Application Priority Data
Jan. 7, 2020 (GB) 2000158.2

(51) Int. Cl. F24F 11/39; F24F 13/28

(52) U.S. Cl. CPC F24F 11/39; F24F 13/28; F24F 2110/40

(57) ABSTRACT

An air filter for a heating, ventilation and air conditioning, HVAC, system, the air filter comprising: a housing having an inlet opening and an outlet opening, configured for air to flow along an air flow route between the inlet opening and the outlet opening; a supply spool and a take-up spool mounted to the housing on opposite sides of the air flow route; one or more filter guides mounted to the housing between the supply spool and the take-up spool; a strip of filter medium extending from the supply spool to the take-up spool via the one or more filter guides, with a portion of the filter medium extending across the air flow route; and a driver arranged to advance the filter medium to change the portion of the filter medium extending across the airflow route. Air filtration systems, HVAC devices and HVAC systems comprising the air filter.

### RELATED APPLICATION

The present application is a national stage application under 35 U.S.C. § 371 of International Application No. PCT/EP2021/050201, filed 7 Jan. 2021, which claims priority to Great Britain Patent Application No. 2000158.2, filed 7 Jan. 2020. The above referenced applications are hereby incorporated by reference in their entirety.

### TECHNICAL FIELD

The invention relates to air filters for air handling systems. In particular, the invention relates to filters for fixed HVAC (heating, ventilation and air conditioning) systems which are, for example, built into commercial or industrial buildings. The invention can also be applied in domestic heaters or air conditioners.

### BACKGROUND

HVAC systems take in large volumes of air from, for example, an urban environment. Such air may comprise dust, pollution and other health hazards such as fungal spores. To remove or reduce the particulates content in the air, HVAC systems typically include an air filter.

Additionally, some elements of an HVAC system, such as heat exchanger coils, provide a warm environment which is prone to biological growth of, for example, any biological spores or seeds which may be drawn into the HVAC system. Such elements typically have an air filter at or near to their air intake in order to reduce the chance of such biological growth taking place.

In conventional systems, each air filter is a simple arrangement of a filter medium fixed across an air flow route. Over time, the filter medium becomes partially or completely blocked, reducing or stopping air flow in the HVAC system. As a result, the air filter must be accessed regularly in order to clean or change the filter medium. This incurs operational costs and inconvenience for operators and occupants of buildings having HVAC systems.

A total of about 70,000 air conditioning units are installed in the UK each year, each of which has a lifetime of approximately 15 years. However, each unit requires a visit from a technician every three months in order to clean or replace air filters to maintain maximum efficiency of the unit. Clogged filters result in reduced air flows, requiring fan motors operate for longer than is necessary. Even at relatively low levels of clogging, the air flow may be too low to achieve required temperatures, and a control system may run air conditioning unit motors continuously, leading to inefficiency.

Accordingly, it is desirable to provide an air filter for an air handling system, wherein the air filter does not need to be accessed as frequently as in conventional systems.

### SUMMARY

According to a first aspect, the present invention provides an air filter device for a heating, ventilation and air conditioning, HVAC, system, the air filter device comprising: a housing having an inlet opening and an outlet opening, configured for air to flow along an air flow route between the inlet opening and the outlet opening; a supply spool and a take-up spool mounted to the housing on opposite sides of the air flow route; one or more filter guides mounted to the housing between the supply spool and the take-up spool; a strip of filter medium extending from the supply spool to the take-up spool via the one or more filter guides, with a portion of the filter medium extending across the air flow route; and a driver arranged to advance the filter medium to change the portion of the filter medium extending across the air flow route.

With such an air filter, the portion of filter medium extending across the air flow route can be replaced using the driver, without requiring physical access to the air filter.

Optionally, the filter medium is a flexible filter medium.

Optionally, the one or more filter guides comprises a pair of filter guides arranged to redirect the strip as a barrier between the air flow route and the supply spool and/or the take-up spool. Such a barrier reduces build-up of dust or other particles in the mechanism of the air filter.

Optionally, the one or more filter guides comprises a filter guide arranged in the air flow route. Such a filter guide inhibits the filter medium from moving along the air flow route.

Optionally, the filter guide arranged in the air flow route is arranged to increase a length of the portion of the filter medium extending across the air flow route. Such a filter guide arrangement increases the effective filtering surface area of the air filter, and decreases the rate of partial or complete blockage of the air filter.

Optionally, the air filter unit further comprises a sensor for measuring an advancement of the strip. Such a sensor improves the precision with which the driver can be controlled.

The one or more filter guides may be configured as fixed guide surfaces, or as guide rollers. Optionally, the one or more filter guides comprises a filter guide configured as an encoder for counting a length of the strip which has passed the filter guide. Such an encoder improves the precision with which the driver can be controlled.

Optionally, the strip comprises a first attachment surface for releasable attachment to the supply spool and a second attachment surface for releasable attachment to the take-up spool. Releasable attachments make it easier for an operator to maintain the air filter.

Optionally, the supply spool and the take-up spool are detachable from the housing. Detachable spools make it easier for an operator to maintain the air filter.

Optionally, the air filter unit further comprises a sprayer arranged to apply a treatment spray to the portion of the filter medium extending across the air flow route, or to apply a treatment spray into an air flow travelling downstream from the air filter unit. This allows the air filter to chemically increase air quality as well as physically filtering the air. By applying the treatment spray to an air flow travelling downstream, a downstream device, such as an HVAC device or coil, may be treated in addition to the air filter unit.

Optionally, the air filter unit further comprises a sensor for detecting a pressure differential across the portion of the filter medium extending across the air flow route, or for detecting clogging of the portion of the filter medium extending across the air flow route. This allows the air filter to automatically detect when the filter medium should be advanced.

Optionally, the means to detect clogging of the filter medium comprises a switch operable by movement of the filter medium in response to a pressure differential across the filter medium.

Optionally, the air filter unit is for an air handling unit having an air intake opening, and the air filter unit further comprises mounting means for mounting the air filter unit as an attachment to the air handling unit so that the outlet opening of the air filter attachment at least partially overlaps the intake opening of the air handling unit. This allows the air filter unit to be used with air handling units.

According to a second aspect, the present invention provides an air filtration system for a heating, ventilation and air conditioning, HVAC, system, the air filtration system comprising: an air filter unit of the first aspect; and control circuitry configured to control the driver to change the portion of the filter medium extending across the air flow route.

Optionally, the control circuitry is configured to control the driver to advance the strip by a predetermined length or to activate the driver for a predetermined interval of time.

Optionally: the control circuitry is configured to automatically activate the driver at one or more predetermined times; or the air filter system comprises a sensor for detecting a pressure differential as described above, and the control circuitry is configured to automatically activate the driver in dependence upon the detected pressure differential or the detected clogging.

Optionally, the control circuitry comprises a display configured to indicate the status of the filter medium. This allows an operator to monitor the status of the air filter unit.

Optionally, the control circuitry comprises a user input means. This allows an operator to control the driver in conjunction with, or as an alternative to, automatic control by the control circuitry.

Optionally, the control circuitry includes a manual override switch for selectively operating the drive means. This is particularly useful for assisting an operator in replacing a strip of filter medium that has been completely used in the air filter unit.

Optionally, the user input means is situated remotely from the air filter unit. This allows an operator to control the strip of filter medium without directly accessing the air filter unit which may, for example, be located in a ceiling space.

Optionally, the control circuitry is operable to send a signal indicative of a status of the filter medium, over a communications network, to a remote location. This may, for example, be used to provide an alert to an operator when a strip of filter medium has been completely, or nearly completely, used in the air filter unit.

Optionally, in the air filtration system, the air filter unit comprises all or part of the control circuitry. The control circuitry may make local decisions, such as controlling the driver according to a pre-programmed schedule, and in such cases the design of the air filtration system can be simplified by including the control circuitry in the air filter unit.

Optionally, the air filtration system comprises: a plurality of air filters of the first aspect; and a central control unit comprising control circuitry configured to control the driver of each of the plurality of air filters.

According to a third aspect, the present invention provides a heating, ventilation and air conditioning, HVAC, device comprising an air intake opening, and an air filter of the first aspect or an air filter system of the second aspect, wherein the air filter is mounted on the air intake opening, and the HVAC device is an evaporator, a condenser, a fan or a fan coil unit.

According to a fourth aspect, the present invention provides a heating, ventilation and air conditioning, HVAC, system comprising: an HVAC device that is an evaporator, a condenser, a fan or a fan coil unit; and an air filter of the first aspect or an air filter system of the second aspect, wherein the air filter is arranged upstream of the HVAC device.

According to fifth aspect, the present invention provides an air filter attachment for an air handling unit having an air intake opening, the air filter attachment comprising a housing having an inlet opening and an outlet opening, a supply spool and a take-up spool mounted to the housing on opposite sides of the inlet opening, a strip of a flexible filter medium extending from the supply spool to the take-up spool so that a length of the filter medium covers the inlet opening, drive means for advancing the flexible filter medium by a distance sufficient to replace the length of filter medium covering the inlet opening with a fresh length of filter medium, control means to control the operation of the drive means; and mounting means for mounting the air filter attachment to the air handling unit so that the outlet opening of the air filter attachment at least partially overlaps the intake opening of the air handling unit.

In any of the aspects, the one or more filter guides optionally comprises a filter guide that is detachable from the housing. Detachable guides further assist with maintaining the air filter.

In any of the aspects, the air filter optionally comprises means to resist the advance of the filter medium strip in order to tension the part of the strip which extends across the air flow path. For example, a spool or guide may comprise a ratchet and pawl mechanism or a friction joint.

In any of the aspects, the air filter optionally comprises a guide which is roller encoder.

In any of the aspects, the driver is optionally a motor, and preferably a stepper motor or a continuous motor.

In any of the aspects, the strip of filter material optionally comprises end attachments configured such that two filter strips can be releasably attached end to end.

In any of the aspects, the housing optionally comprises an opening and/or a detachable portion arranged to provide access to the supply spool or the take-up spool.

In any of the aspects, the sprayer is optionally also a structural support for the housing.

### BRIEF DESCRIPTION OF THE DRAWINGS

FIG. 1A is a schematic illustration of an air filter device according to an embodiment;

FIG. 1B is a schematic cross-section view of the air filter device;

FIG. 2 is a partial schematic perspective view, illustrating an arrangement of spools and guides in an embodiment;

FIG. 3 is a schematic illustration of an HVAC device according to an embodiment;

FIG. 4 is a schematic illustration of an HVAC system according to an embodiment.

### DETAILED DESCRIPTION

In the accompanying figures, x-, y- and z-axes are used to indicate relative rotated viewpoints in different figures.

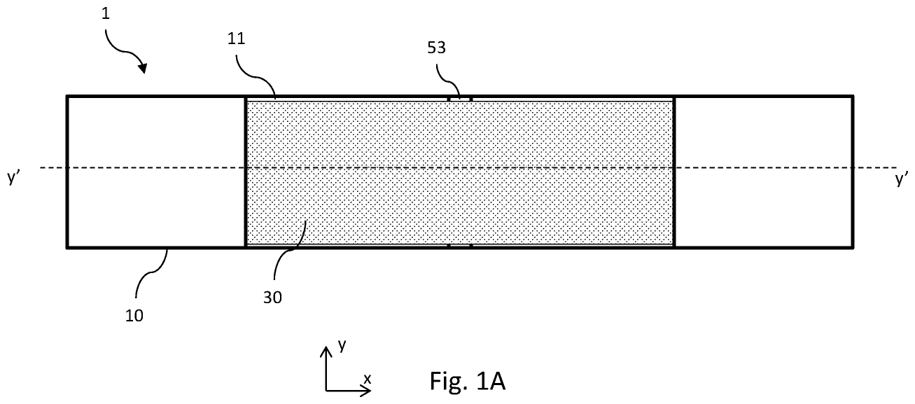

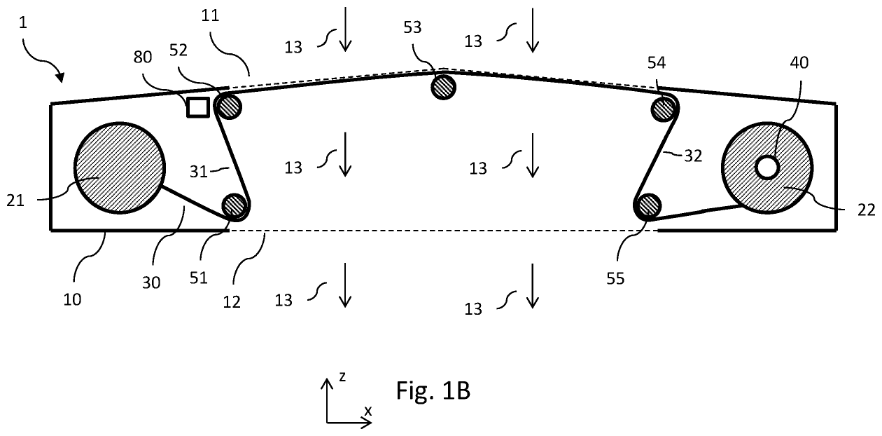

FIG. 1A is a schematic illustration of an air filter device 1 according to an embodiment, facing towards an inlet of the air filter device 1.

The air filter device 1 comprises a housing 10 comprising an inlet opening 11 for an air flow route 13. A filter medium 30 extends across the air flow route 13. Accordingly, air that flows through the air filter device 1 must pass through the filter medium 30.

The housing 10 may, for example, be constructed from sheet metal, preferably a light material such as aluminium. Additionally or alternatively, the housing may comprise one or more moulded plastic sections, or composite materials such as glass-reinforced plastics or carbon-fibre reinforced plastics.

The filter medium 30 is a porous material such as a mesh which captures particles, such as pollution or spores, from air as it passes through. The material may alternatively be a non-woven fabric or a cloth made from natural or synthetic fibres. A pore size of the filter medium 30 may be chosen according to known principles, in view of a required air flow through the filter and expected size of particles which are to be filtered. Typically, in commercial premises, filters having a pore size of 3 to 10 microns are used, although the invention is applicable to any pore size. In order to reduce damage to the strip as it is used in the air filter device 1, the strip may have some reinforcement along its long edges. For example, the edges of the porous material may be heat sealed.

In general, the inlet opening 11 (and outlet opening 12 shown in FIG. 1B) are sized according to an air handling device or air handling system in which the air filter device 1 is to be used. For example, if connected to a circular air duct, the inlet opening 11 may be a similar circular shape to match the air flow route of the duct.

According to the invention, the filter medium 30 is a strip of substantially fixed width. If the air flow route 13 of the air filter device 1 does not have a rectangular cross section, then the width of the filter medium 30 may be chosen to match a widest part of the air flow route 13.

FIG. 1B is a schematic cross-section of the air filter device, viewed in the plane y′ that is illustrated using a dashed line in FIG. 1A.

The housing 10 additionally comprises an outlet opening 12. Air can flow through the air filter device 1 along the air flow route 13 between the inlet opening 11 and the outlet opening 12.

Mounted to the housing 10, on opposing sides of the air flow route 13, the air filter device 1 further comprises a supply spool 21 and a take-up spool 22. A strip of filter medium 30 extends across the air flow route 13, from the supply spool 21 to the take-up spool 22. The spools 21, 22 may be located to minimize the required width of the filter medium 30. For example, in the rectangular example shown in FIG. 1A, the spools 21, 22 are preferably arranged on the shorter sides of the air flow route 13.

The filter medium 30 is provided as a continuous flexible strip which is initially wound around the supply spool 21 and gradually advanced across the air flow route 13 to the take-up spool 22. The filter medium 30 could alternatively be provided as a series of linked sections, in which case each individual section need not be flexible, so long as the strip can bend at the linking points between sections. As the filter medium 30 is wound onto the take-up spool 22, dust or other particles are captured between turns of the filter medium 30, reducing the operator's exposure and the general loss of dust when the filter medium 30 eventually needs to be replaced.

In the illustrated embodiment, the filter medium 30 extends across the inlet opening 21. However, in other embodiments, the filter medium 30 could equally extend across the outlet opening 22, or across an intermediate part of the air flow route 13.

The filter medium 30 is advanced using a driver 40, such as a motor arranged to rotate the take-up spool 22. The motor may be a stepper motor configured to turn the take-up spool 22 by a predetermined increment, or may be a continuous motor configured to turn the take-up spool 22 according to an external control signal. By rotating the take-up spool 22, the driver 40 changes a portion of the filter medium 30 which currently extends across the air flow route 13. Thus, when a portion of the filter medium 30 has become, or is expected to have become, partially or completely blocked, the driver 40 can be used to move the filter medium 30 along the path between the spools 21, 22 and present a fresh portion of the filter medium 30 across the air flow route 13. This means that the air filter device 1 can be maintained in an effective state without requiring physical access to the air filter in order to clean or replace the filter. Additionally, by rolling up a used portion of the filter medium 30, a risk of air contamination when the filter is eventually disturbed and replaced (i.e. after the supply spool 21 has run out of fresh filter medium 30) is reduced.

The filter medium 30 may be held under tension between the supply spool 21 and the take-up spool 22, or may be constrained by guides along its whole length, so that the filter medium 30 cannot be carried with air flow along the air flow route 13. In the embodiment shown in FIG. 1B, the filter medium 30 is held under tension and is also guided to follow a path via filter guides 51 to 55 mounted to the housing 10 at points between the supply spool 21 and the take-up spool 22. Tension in the length of filter medium extending across the air flow route may, for example, be provided using the driver 40 on one side of the air flow route and a tensioning device which engages the filter medium at a position on the other side of the air flow route. The tensioning device may be a ratchet and pawl mechanism or a friction joint on the supply spool 21, or on one of the filter guides 51 or 52.

The filter guides 51 to 55 may take the form of any protrusion mounted on the housing 10, and provide guidance as passive obstacles for the filter medium 30. For example, the filter guides may be flanges parallel to one or both side edges the filter medium 30, or may be struts extending between opposing walls of the housing 10 across a whole width of the filter medium 30. Preferably, the filter guides 51 to 55 are provided as freely rotating rollers so that they do not provide unnecessary friction when guiding the filter medium 30.

The driver 40 could instead be arranged to rotate the supply spool 21, one of the guides 51 to 55, or could be a linear driver arranged to drive the filter medium 30 at a point between the spools. In particular, if the filter medium 30 is constrained by guides along its whole length, then the filter medium 30 can be pushed rather than pulled.

In this embodiment, each of the spools 21, 22 is isolated from the air flow route 13 by a portion 31, 32 of the filter medium 30 which is arranged to define a roller chamber that is separated from the air flow route 13. This arrangement of the filter medium 30 is achieved by providing respective pairs of filter guides 51, 52 and 54, 55 that are arranged to redirect the strip 30 as a barrier between the air flow route 13 and, respectively, the supply spool 21 and the take-up spool 22. This has the advantage of reducing build-up of dust or other particles in the housing 10, increasing the effectiveness and reliability of the air filter device 1 over its lifetime. Each of the pairs of filter guides 51, 52 and 54, 55 is provided independently and may be omitted. For example, the filter guides 54, 55 may be omitted in some embodiments because dust is, to some extent, expected to reach the take-up spool 22 regardless of any barrier, as a result of the filter medium 30 being wound onto the take-up spool 22. One the other hand, in some circumstances the filter guides 54, 55 may be regarded as more important than filter guides 51, 52 because the filter guide 55 will compress dust and other particles into the filter medium 30 before it is wrapped around the take-up spool 22, and thereby reduce the escape of filtered material when the filter medium 30 is replaced.

Additionally, in this embodiment, the air filter device 1 comprises a filter guide 53 arranged in the air flow route 13. This has the effect of supporting the filter medium 30 in the air flow route 13, so that the shape of the filter medium remains fixed, and a change in pressure cannot enlarge a gap between the filter medium 30 and the housing 10 for unfiltered air to pass through the air filter device 1. Providing one or more filter guides 53 in the air flow route 13 reduces the required tension for holding the filter medium 30 in place, but the filter guide 53 may be omitted in some embodiments.

Locating one or more filter guides 53 in the air flow route 13 has the further advantage of modifying the shape formed by the portion of the filter medium 30 that extends across the air flow route 13. In particular, a filter guide 53 can be placed to increase a length of the portion of the filter medium 30 extending across the air flow route 13, and thereby increase the surface area of the filter through which air flows. By increasing the surface area of the filter, the amount of air flow per unit surface area is reduced, and therefore the rate at which the filter becomes partially or completely blocked is reduced. For example, in the embodiment shown in FIG. 1B, the inlet opening 21 has a convex shape, and the filter guide 53 is positioned relative to the filter guides 52 and 54 in order to guide the filter medium 30 in a convex shape that conforms with the inlet opening 21. The shape could alternatively follow an arc or a concave surface, and more complex shapes are possible. For example, multiple filter guides could be placed in the air flow route 13 to guide the filter medium 30 along a zig-zag or sawtooth path that further increases the surface area for filtering air.

In order to effectively use the driver 40 to present a fresh portion of the filter medium 30 across the air flow route 13, it is desirable to determine how far the strip of filter medium 30 is moved by the driver 40.

In a simple example, this determination can be inferred based on how long the driver 40 is activated for. For example, if the driver 40 is a stepper motor arranged to rotate the take-up spool 22, then each rotation step will correspond to a certain movement distance of the filter medium 30. However, this approach requires some mathematical correction in order to be accurate. In particular, the distance by which the filter medium 30 moves depends on both the rotation angle and the effective radius of the take-up spool, and the effective radius of the take-up spool depends upon how far the filter medium 30 has already been wrapped around the take-up spool. Additionally, the used filter medium may have a different thickness from the fresh filter medium prior to use. More specifically, the used filter medium may have on its surface a layer of particulate matter that has been filtered from the air. This change in thickness of the filter medium wrapped around the take-up spool may reduce the accuracy of any mathematical correction.

A more accurate way to determine how far the strip of filter medium 30 is moved by the driver 40 comprises configuring one of the filter guides 51 to 55 as an encoder for counting a length of the strip 30 which has passed the filter guide. No mathematical correction is required, because the filter medium 30 only moves past the guides, without changing the radius of the filter guides. Preferably the filter guide used for this purpose is a roller comprising a rotary encoder. Accuracy of the rotary encoder is increased when a contact surface between the filter guide and the filter medium 30 is increased, and can be improved by locating the rotary encoder in a filter guide at which a direction of the filter medium 30 changes by a large angle, preferably more than 90 degrees. For example, in the example arrangement shown in FIG. 1B, filter guides 51 and 55 would be preferred over filter guide 53 for use with a rotary encoder.

The strip 30 may be additionally provided with a line of traction-increasing material, such as silicone or rubber, along its length, in order to increase accuracy of the encoder. Additionally or alternatively, traction may be increased by including a sheath of traction-increasing material around one or all of the filter guides.

In an alternative arrangement, the filter medium strip may be provided at intervals with regions of contrasting colour or reflectivity, which can be detected by an optical detector means mounted to the housing. The amount of advance of the filter medium may then be determined by counting the number of regions detected as the filter medium is advanced. The output from the optical detector means may be fed to a counter which totals the number of detections, and stops the driver 40 from advancing the filter medium any further when the total number reaches a predetermined threshold corresponding to the dimension of the air inlet opening in the strip advance direction. The filter medium strip may be provided with contrasting regions spaced apart by a distance equal to the dimension of the air inlet opening, and the control means may simply advance the filter medium strip until the next contrasting region is detected.

As an additional optional feature, in the embodiment shown in FIG. 1B, the air filter device 1 comprises a sprayer 80 arranged to apply a treatment spray to the portion of the filter medium 30 that is to extend across the air flow route 13. This allows the air filter to chemically increase air quality as well as physically filtering the air. For example, as mentioned in the background, the air in an HVAC system may comprise biological components such as fungal spores. Applying a treatment such as an anti-fungal spray can reduce the growth of such biological components. By providing a sprayer 80 which can apply the treatment spray regularly, for example every time the filter medium 30 is advanced, the air filter device 1 can effectively continuously provide anti-fungal treatment to air passing through the filter, without this effect wearing off during the lifetime of the filter strip 30. The sprayer 80 may be attached to the housing, and may, for example, be contained in a strut supporting the housing or in one of the filter guides 51 to 55.

Alternatively, the sprayer 80 may be arranged to apply the treatment spray into an air flow as it travels through the air filter unit and towards a downstream part of an HVAC device or system, such as a fan coil unit (FCU). By treating the air flow, the treatment spray is applied to the downstream part. For example, if the treatment spray comprises an anti-fungal, the sprayer 80 may also have the effect of preventing biological growth on or in the downstream part.

As an addition or alternative to the above-described anti-fungal spray, the treatment spray may comprise a room treatment for persons occupying a space such as a room which is served by an HVAC device or system. This may for example be a scent or a health spray such as an asthma treatment. For example, the sprayer 80 may comprise or be connected to a commercial scent machine. When the air flow passes through the treated filter medium, or the air flow is directly treated with the treatment spray, the room treatment is added to the air flow. Subsequently the air flow may be directed through the space such as a room. When the air flow is directed through the space, the room treatment (e.g. scent or health spray) may improve the air quality for persons in the space.

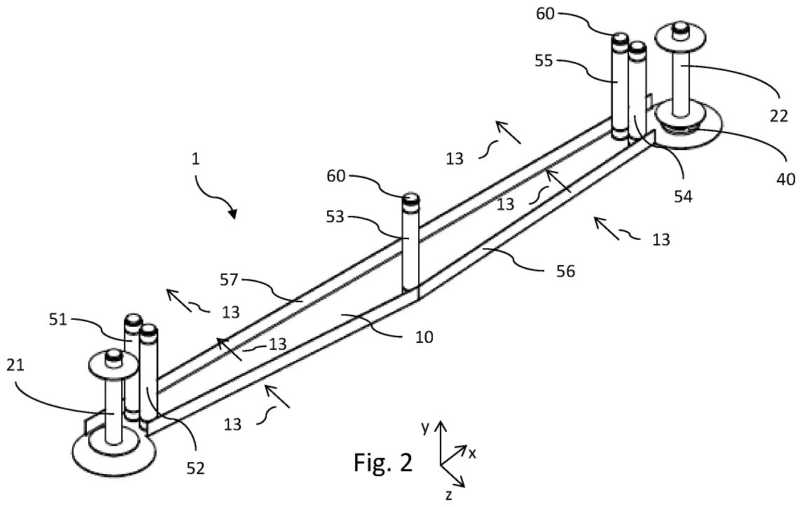

FIG. 2 is a partial schematic perspective view, illustrating an arrangement of spools and guides in an embodiment. The filter medium 30 and one side of the housing 10 are omitted in this view, so that specific details of the embodiment can be seen more easily.

As shown in FIG. 2, the air flow route 13 (between the previously-described pairs of rollers 51, 52 and 54, 55) may be substantially larger than the parts of the housing in which the spools 21, 22 are located.

Additionally, in the embodiment shown in FIG. 2, each of the spools 21, 22 and some of the filter guides 51 to 55 comprise attachment means 60 by which they are detachable from the housing 10. For example, the spools and filter guides may be provided with a resilient portion such that they can be compressed and removed from a corresponding engagement portion (e.g. socket or protrusion) on the housing 10. More specifically, the resilient portion may be a plastic portion, while a central portion of the filter guide is constructed from aluminium, such as aluminium tubing. By making any of the guides or spools detachable, maintainability of the air filter device 1 is improved by allowing replacement of components without replacing the housing 10.

Additionally, by making the spools 21, 22 detachable, replacement of the filter medium 30 can be made easier. For example, when a strip of filter medium 30 has been completely used and transferred to the take-up spool 22, the filter medium 30 can be removed while remaining wrapped around the take-up spool. The empty supply spool 21 can then be swapped into the take-up spool position 22, and a new supply spool 21 having a fresh strip of filter medium 30 wrapped thereon can be put in the supply spool position 21. In this example, the supply spool 21 and the take-up spool 22 are substantially identical and are distinguished only by their position in the air filter. A hinged or detachable portion may be provided in the housing 10 to allow access to each of the spools 21, 22.

Additionally or alternatively, the strip of filter medium 30 may be attachable to and detachable from the spools 21, 22. For example, at or near each end, the strip may comprise an attachment surface for releasable attachment to a spool. The attachment surface may, for example, be a burr-type hook-and-loop surface for engaging with a corresponding surface on the spool. For example, transverse Velcro strips may be provided perpendicular to the length direction of the filter medium strip 30. In another example, the attachment surface may comprise an adhesive, or the attachment surface may be replaced with an alternative clamping arrangement for attaching the strips 30 to the spools 21,22 and/or to each other.

Advantageously, the attachment surfaces at each end of the strip 30 may be configured to engage with each other (for example one being a hook surface and the other being a loop surface). Alternatively, the strip 30 may be provided with a separate way of connecting two strips 30 end to end, such as a string attachment on one end and a metal loop on the other end. Such end to end connection configurations can either be used to produce a longer strip, or can be used when replacing a used strip in order to feed a fresh strip through the filter guides.

More specifically, when the strip 30 has been completely unwound from the supply spool 21, an end of the strip 30 may still be attached to the supply spool 21, and a portion of the filter medium may still extend across the air flow route 13. At this point, the end of the old strip 30 may be detached from the supply spool 21 and attached to the end of a fresh strip 30.

The remaining portion of the old strip 30 may then be wound onto the take-up spool 22, pulling a first portion of the new strip 30 through the guides 51 to 55, into position for use filtering air. An operator may perform this winding manually, or may operate the driver 40, for example using a manual override control attached to the air filter device 1.

The end of the old strip 30 may then be detached from the new strip 30, and the leading end of the new strip 30 attached to an empty take-up spool 22. The used strip 30 may then be unwound, cleaned or otherwise refreshed, and re-wound onto its spool so that it can be used again.

As additionally shown in FIG. 2, the housing 10 may comprise one or more flanges 56 and 57 along an edge of the inlet opening 11 or the outlet opening 12. The flanges 56 and 57 act as further guides for the filter strip 30, inhibiting the filter strip from leaving the housing 10. Further flanges may be provided to define a narrow channel along each side of the housing 10, constraining the strip 30 to move along a particular path between the walls of the housing. In that case, it may be unnecessary to include any guides extending between opposing walls of the housing 10 across a whole width of the filter medium 30 if the filter medium is sufficiently rigid.

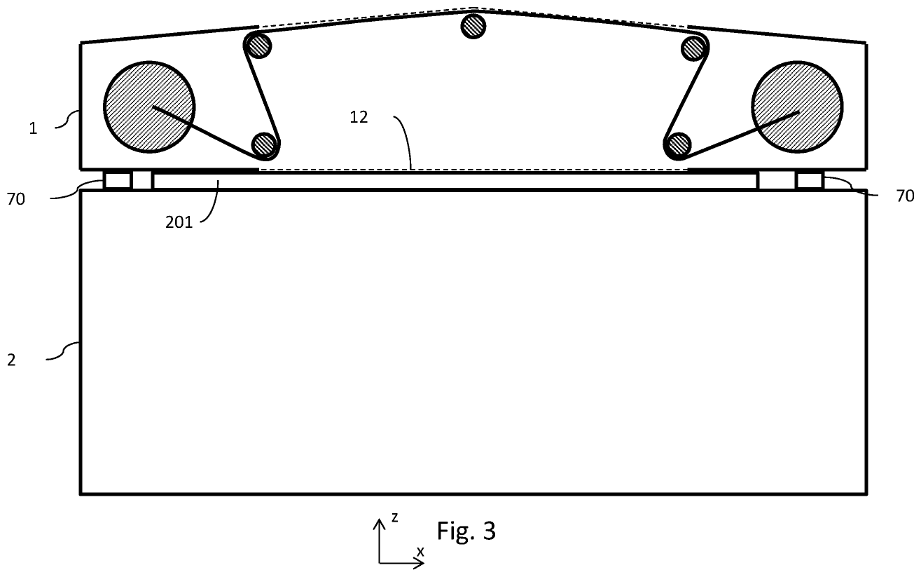

FIG. 3 is a schematic illustration of an HVAC device according to an embodiment. In this embodiment, an air filter device 1 is mounted on the HVAC device 2. The outlet opening 12 of the air filter device 1 is aligned with an air intake opening 201 of the HVAC device 2.

Additionally, in this embodiment, the air filter device 1 comprises a mounting portion 70 for mounting the air filter device 1 on the HVAC device 2. The mounting portion may, for example, comprise one or more holes for screws or bolts. The mounting portion may be one of a plurality of possible mounting portions provided for mounting the air filter device 1 on different devices 2. Alternatively, the air filter device 1 may be provided as an integral part of the HVAC device 2, in which case the mounting portion 70 may be omitted, and the housing 10 may be integral with a housing of the HVAC device 2.

The HVAC device 2 may, for example, be a heat exchange coil such as an evaporator or a condenser, or a fan. In addition to its conventional meaning, the term “HVAC system” or “HVAC device” as used herein includes systems or devices which do not provide all of heating, ventilation and air conditioning. For example, HVAC system and HVAC device includes systems which do not provide cooling and systems which do not provide heating. More generally, the air filter device 1 may be similarly configured for, mounted on or integrated in any air handling device having an air intake opening.

In order to control the driver 40 to advance the filter medium when necessary, the air filter device 1 may be connected to control circuitry. The control circuitry may for example comprise a general purpose processor or a dedicated application-specific processor (ASIC). In the simplest example of control circuitry, the driver 40 may be connected to a remote control device for an operator to manually control the driver 40 from a remote location. For example, the air filter device 1 and its driver 40 may be mounted in a ceiling space in a building, and the control device may be provided in an accessible location, such as by being mounted, for example to a wall, in the accommodation space of the building. This simple case already has an advantage over prior art with a fixed filter, because the operator does not need to gain direct access to the air filter device 1 in order to present a fresh portion of filter medium 30 across the air flow route 13.

Preferably, however, the control circuitry is configured to automatically control the driver 40 to change the portion of the filter medium 30 extending across the air flow route 13. For example, the control circuitry may be configured to control the driver 40 to advance the strip 30 by a predetermined length, such as a length corresponding to the portion of the strip 30 that extends across the air flow route 13. As described above, the length of advance may be controlled by taking mathematical account of changes in the spool radius, or by using a sensor such as an encoder or optical sensor for counting the advance. The automatic change may again be triggered manually by an operator, but with a higher layer of abstraction where the operator indicates that the portion of the filter extending across the air flow route 13 needs to be replaced, rather than indicating a specific operation of the driver 40.

Furthermore, the control circuitry may preferably be configured to automatically determine when the filter needs to be replaced. In a simple example, the control circuitry may comprise a timer and may be configured with a schedule indicating an expectation of when the filter will need to be replaced. The control circuitry may then be configured to activate the driver 40 at one or more predetermined times defined in the schedule.

Alternatively, the air filter device 1 may comprise a sensor for detecting a pressure differential across the portion of the filter medium 30 extending across the air flow route 13. The sensor may be a sensor for directly measuring pressure on either side of the filter medium 30 or may, for example, be a sensor for measuring an air flow through the air filter device 1 or a sensor for detecting force on or displacement of the filter medium 30 along the air flow route 13. In one specific example, the filter guide 53 that is arranged in the air flow route 13 may comprise a pressure sensor or simple switch for detecting that the filter medium 30 is pressed against the guide 53 more strongly than it would be only due to tension in the filter medium 30. The above described pressure gradient, change of air flow, or forces on the filter medium 30 are all indicative of the possibility that the portion of the filter medium 30 extending across the air flow route 13 is partially or entirely blocked. More generally, the air filter device 1 may comprise any sensor capable of detecting clogging of the filter medium. The control circuitry may be configured to compare one or more of these indications to a threshold in order to detect a condition in which the filter medium 30 should be advanced in order to replace the portion of the filter medium extending across the air flow route 13.

The control circuit may further include a display for displaying a representation of the condition of the filter medium, based on the sensed pressure difference, air flow or deflection of the filter medium.

Yet further, the control circuitry may be configured to automatically control the sprayer 80 (if present). For example, the control circuitry may be configured to control the sprayer 80 to spray the filter medium when it is being advanced by the driver 40 or may be configured to control the sprayer 80 to spray the portion of filter medium extending across the air flow route, according to a schedule or after the filter medium has been advanced.

Furthermore, the control circuitry may be configured to control tension in the filter medium 30, for example by measuring a current in the driver 40 during an operation to advance the filter medium 30. The air filter device 1 may comprise a tension sensor for this purpose. The tension sensor (if present) may also be used as a substitute for a pressure difference sensor as described above. More specifically, a pressure differential would provide a force to deform the filter medium 30 and increase tension.

By combining automatic determination that the filter portion extending across the air flow route 13 needs to be replaced and automatic advancement of the filter medium 30, the control circuitry may automatically maintain the air filter device 1 until the strip 30 is fully used.

The control circuitry may be provided as part of the air filter device 1, for example located inside the housing 10. Alternatively, control circuitry may be remote from the air filter device 1, and provided separately from the air filter device 1 in an air filtration system. For example, the control circuitry may be connected to the air filter device 1 via a communication network.

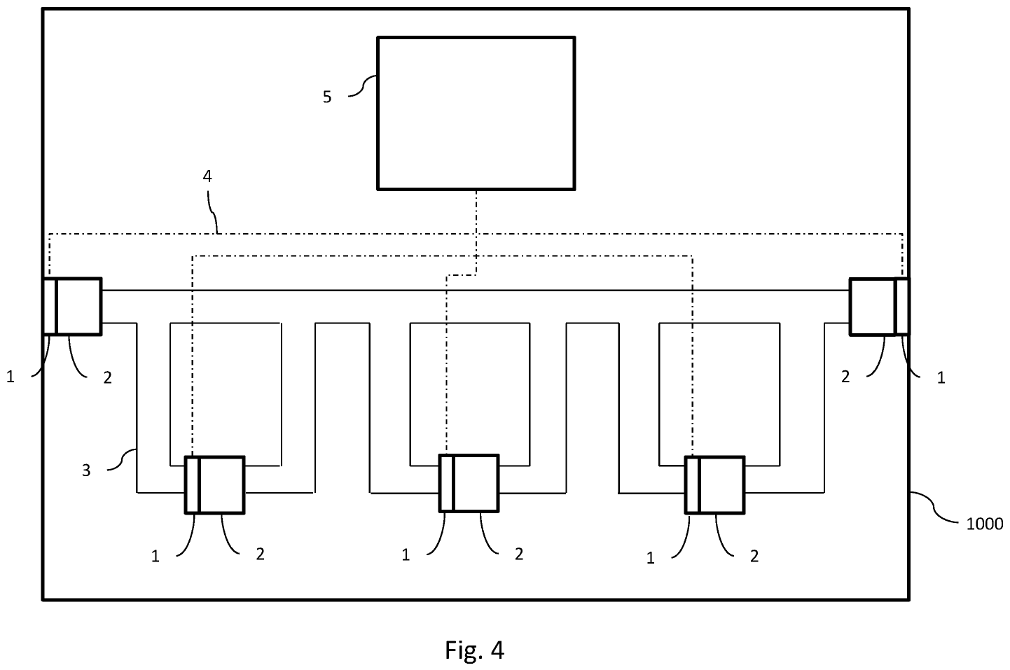

An example of remote control circuitry is shown in FIG. 4. More specifically, FIG. 4 shows an HVAC system for a building 1000.

The HVAC system includes a plurality of HVAC devices 2 connected by air ducts 3. As shown in FIG. 4, some HVAC devices 2 may be connected to or mounted on an exterior of the building 1000, as is the case, for example, with roof-mounted condensers. Additionally, some HVAC devices 2 may be internal to the building. Additionally, although not shown, the HVAC system is connected to one or more rooms within the building 1000 to circulate air through the rooms.

Additionally, the HVAC system comprises an air filtration system comprising a plurality of air filters 1 connected to a central control unit 5.

Each of the air filters 1 may be part of or mounted on a respective HVAC device 2, as shown in FIG. 3. Alternatively, each of the air filters 1 may be connected upstream of a respective HVAC device 2 via the air ducts 3.

The central control unit 5 comprises control circuitry configured to control a driver 40 in each of the air filters 1. For example, the central control unit 5 may be configured to receive sensor data from a pressure differential sensor in each air filter device 1, as described above, and to send a control signal to the driver 40 in dependence upon the sensor data.

The central control unit 5 may be connected to each of the air filters 1 by a physical or wireless connection 4, such as a network within the building 1000. This may be a dedicated network for the air filtration system or may be a general network (e.g. LAN) that exists in the building. Furthermore, the central control unit 5 need not be in the building 1000 with the HVAC system. For example, each air filter device 1 may be connected to the Internet, and the central control unit 5 may be provided as a server of an HVAC maintenance company managing multiple buildings. The central control unit 5 may further be configured to, for example, indicate when a strip 30 of an air filter device 1 has been fully used and/or alert an operator when a replacement strip 30 is required. This alert may be given on a display associated with the central control unit 5, or as a message sent to a mobile device such as a mobile telephone.

1. An air filter unit for a heating, ventilation and air conditioning, HVAC, system, the air filter unit comprising:
a housing having an inlet opening and an outlet opening, configured for air to flow along an air flow route between the inlet opening and the outlet opening;
a supply spool and a take-up spool mounted to the housing on opposite sides of the air flow route;
one or more filter guides mounted to the housing between the supply spool and the take-up spool;
a strip of filter medium extending from the supply spool to the take-up spool via the one or more filter guides, with a portion of the filter medium extending across the air flow route; and
a driver arranged to advance the filter medium to change the portion of the filter medium extending across the air flow route.

2. An air filter unit according to claim 1, wherein the filter medium is a flexible filter medium.

3. An air filter unit according to claim 1, wherein the one or more filter guides comprises a pair of filter guides arranged to redirect the strip as a barrier between the air flow route and the supply spool and/or the take-up spool.

4. An air filter unit according to claim 1, wherein the one or more filter guides comprises a filter guide arranged in the air flow route.

5. An air filter unit according to claim 4, wherein the filter guide arranged in the air flow route is arranged to increase a length of the portion of the filter medium extending across the air flow route.

6. An air filter unit according to claim 1, further comprising a sensor for measuring an advancement of the strip.

7. An air filter unit according to claim 6, wherein the sensor for measuring an advancement of the strip is a filter guide configured as an encoder for counting a length of the strip which has passed the filter guide.

8. An air filter unit according to claim 1, wherein the strip comprises a first attachment surface for releasable attachment to the supply spool and a second attachment surface for releasable attachment to the take-up spool.

9. An air filter unit according to claim 1, wherein the supply spool and the take-up spool are detachable from the housing.

10. An air filter unit according to claim 1, further comprising a sprayer arranged to apply a treatment spray to the portion of the filter medium extending across the air flow route, or to apply a treatment spray into an air flow travelling downstream from the air filter unit.

11. An air filter unit according to claim 1, further comprising a sensor for detecting a pressure differential across the portion of the filter medium extending across the air flow route, or for detecting clogging of the portion of the filter medium extending across the air flow route.

12. An air filter unit according to claim 11, wherein the sensor for detecting clogging of the filter medium comprises a switch operable by movement of the filter medium in response to a pressure differential across the filter medium.

13. An air filter unit according to claim 1, for an air handling unit having an air intake opening,
wherein the air filter unit further comprises mounting means for mounting the air filter unit as an attachment to the air handling unit so that the outlet opening of the air filter attachment at least partially overlaps the intake opening of the air handling unit.

14. An air filtration system for a heating, ventilation and air conditioning, HVAC, system, the system comprising:
an air filter unit comprising
a housing having an inlet opening and an outlet opening, configured for air to flow along an air flow route between the inlet opening and the outlet opening;
a supply spool and a take-up spool mounted to the housing on opposite sides of the air flow route;
one or more filter guides mounted to the housing between the supply spool and the take-up spool;
a strip of filter medium extending from the supply spool to the take-up spool via the one or more filter guides, with a portion of the filter medium extending across the air flow route; and
a driver arranged to advance the filter medium to change the portion of the filter medium extending across the air flow route; and
control circuitry configured to control the driver to change the portion of the filter medium extending across the air flow route.

15. An air filtration system according to claim 14, wherein the control circuitry is configured to control the driver to advance the strip by a predetermined length or to activate the driver for a predetermined interval of time.

16. An air filtration system according to claim 14, wherein:
the control circuitry is configured to automatically activate the driver at one or more predetermined times; or
the control circuitry is configured to automatically activate the driver in dependence upon a detected pressure differential across the portion of the filter medium extending across the air flow route, or a detected clogging of the portion of the filter medium extending across the air flow route.

17. An air filtration system according to claim 14, wherein the control circuitry comprises a display configured to indicate the status of the filter medium and a user input means.

18. (canceled)

19. An air filtration system according to claim 17, wherein the control circuitry includes a manual override switch for selectively operating the drive means.

20. An air filtration system according to claim 17, wherein the user input means is situated remotely from the air filter unit.

21. An air filtration system according to claim 14, wherein the control circuitry is operable to send a signal indicative of a status of the filter medium, over a communications network, to a remote location.

22-25. (canceled)
